(19) United States
(12) Patent Application Publication
(10) Pub. No.: US 2025/0273770 A1
(43) Pub. Date: Aug. 28, 2025

(54) MULTILAYER BATTERY PACK INSULATOR AND METHOD OF CONSTRUCTION THEREOF

(71) Applicant: FEDERAL-MOGUL POWERTRAIN LLC, Northville, MI (US)

(72) Inventors: XIAODAN QIU, PHOENIXVILLE, PA (US); WILLIAM T. RUBEL, JR., SPRINGLAKE, NJ (US); ERICH ECKHARD WEISSFLOG, NORTHVILLE, MI (US); AXELL BAILON, NORTHVILLE, MI (US); JUNHAN TAO, NORTHVILLE, MI (US)

(21) Appl. No.: 19/063,014

(22) Filed: Feb. 25, 2025

Related U.S. Application Data
(60) Provisional application No. 63/558,467, filed on Feb. 27, 2024.

(51) Int. Cl. H01M 10/658; H01M 10/625; H01M 50/117; H01M 50/128; H01M 50/143

(52) U.S. Cl. CPC H01M 10/658; H01M 10/625; H01M 50/117; H01M 50/128; H01M 50/143; H01M 2220/20

(57) ABSTRACT

A flexible multilayer battery pack insulator for an electric vehicle has a first layer of a coating material having opposite outer and inner sides, a second layer of compressible material having opposite outer and inner sides, and an intermediate fabric layer sandwiched between the inner side of the first layer and the inner side of the second layer, wherein the second layer has a relaxed thickness extending from the inner side of the second layer to the outer side of the second layer, wherein second layer can compress up to 50% of the relaxed thickness and recover to the relaxed thickness.

### CROSS-REFERENCE TO RELATED APPLICATION

This application claims the benefit of U.S. Provisional Application Ser. No. 63/558,467, filed Feb. 27, 2024, which is incorporated herein by reference in its entirety.

### BACKGROUND OF THE INVENTION

### 1. Technical Field

This invention relates generally to thermal insulators, and more particularly to multilayer thermal insulators for inhibiting flame propagation within and from a battery pack of an electric vehicle.

### 2. Related Art

It is known to contain or shield battery packs, including those used in electric vehicle applications, in thermal insulation. A common material used to form such thermal insulation is a fiberglass fabric. Although the fiberglass fabric insulation provides an acceptable level of protection against contamination and environmental temperatures during normal use, the fiberglass fabric insulation does not provide a desired level of protection against flame propagation, such as may be experienced in a thermal runaway condition of one or more cells of the electric vehicle battery pack. As shown in FIGS. 2A-2C, a battery pack 12 and housing 14, also referred to as casing, thereof are shown having a fiberglass insulator between and about cells 16 of the battery pack 12. The fiberglass insulator can result in a thermal runaway condition originating in any one of the cells 16 of the battery pack 12, such that flame propagates from a single cell 16 (FIG. 2A) to multiple cells (FIG. 2C), in less than 10 minutes at a temperature of 1000° C.

It is desired to provide a thermal insulation that inhibits the propagation of flame between cells of a battery pack when exposed to a flame at a distance of about 25 mm for 10 minutes or more at a temperature of 1000° C.-1400° C.

### SUMMARY OF THE INVENTION

It is an object of the present disclosure to provide a flexible multilayer material for use with an electric vehicle battery pack that addresses at least the desire to inhibit the propagation of flame within and from the battery pack for 10 minutes or more at a temperature of 1000-1400° C.

It is a further object of the present disclosure to provide a flexible multilayer material for use with an electric vehicle battery pack that is flexible, lightweight, has a thin, low profile (thickness) to minimize the amount of space occupied by the thermal insulator, and is economical in manufacture and in use.

One aspect of the invention provides a flexible multilayer battery pack insulator for an electric vehicle. The flexible multilayer battery pack insulator includes a first layer provided as a coating layer, a second layer provided as a compressible material, and an intermediate layer sandwiched between the first layer and the second layer.

In accordance with another aspect of the invention, the intermediate layer is provided as a fabric layer.

In accordance with another aspect of the invention, the flexible multilayer battery pack insulator can further include an adhesive layer bonded to an outwardly facing surface of at least one of the first layer and the second layer.

In accordance with another aspect of the invention, the adhesive layer can be a pressure-sensitive adhesive.

In accordance with another aspect of the invention, the coating material of the first layer includes flame resistant/retardant material(s).

In accordance with another aspect of the invention, the coating material of the first layer can withstand heat as high up to 1600° C.

In accordance with another aspect of the invention, the coating material of the first layer can include, in part or in entirety, vermiculite.

In accordance with another aspect of the invention, the coating material of the first layer can include intumescent material.

In accordance with another aspect of the invention, the second layer of compressible material can be provided as a compression pad, 3D textile, spacer fabric having multiple layers of textile fabric, or foam.

In accordance with another aspect of the invention, the second layer of compressible material provides a compression force deflection curve that allows for significant compression and recovery properties, relative to a percentage of a relaxed thickness extending across a width from one side to an opposite side of the second layer.

In accordance with another aspect of the invention, the second layer of compressible material can be provided to compress up to 90% of its relaxed thickness and recover to its original relaxed thickness after being compressed.

In accordance with another aspect of the invention, the intermediate layer can be provided as one or more of a nonwoven material, woven material, and knitted material.

In accordance with another aspect of the invention, the intermediate layer can be made of mineral fibers, if in a nonwoven material, and/or mineral yarns, if a woven or knitted material.

In accordance with another aspect of the invention, the intermediate layer can be made of an inorganic material.

In accordance with another aspect of the invention, the inorganic material can be made of one or more of ceramic material, fiberglass, silica, basalt, s-2 glass, and HR fiberglass.

In accordance with another aspect of the invention, the first, second and intermediate layers are fixed together.

In accordance with another aspect of the invention, the first, second and intermediate layers can be fixed together via a sewing or quilting process.

In accordance with another aspect of the invention, the first layer, the second layer, and the intermediate layer can remain detached from one another other than where fixed together, thereby forming air pockets between the layers.

In accordance with another aspect of the invention, the first, second and intermediate layers can be fixed together via an adhesive.

In accordance with another aspect of the invention, the first layer, the second layer, and the intermediate layer have a combined maximum thickness between about 0.1 mm to 11 mm.

In accordance with another aspect of the invention, a method of constructing a flexible multilayer battery pack insulator is provided. The method includes providing a layer of compressible material; providing a layer of fabric; fixing a coating layer directly to the layer of fabric and fixing the layer of compressible material directly to the layer of fabric, such that the layer of fabric is sandwiched between the coating layer and the layer of compressible material.

In accordance with another aspect of the invention, the method can further include leaving the layer of compressible material and the layer of fabric in detached relation from one another other than where fixed together.

In accordance with another aspect of the invention, the method can further include fixing the layer of compressible material and the layer of fabric together via a sewing or quilting process.

In accordance with another aspect of the invention, the method can further include providing the layer of fabric as one or more of a nonwoven material, woven material, and knitted material.

In accordance with another aspect of the invention, the method can further include providing the layer of fabric being made of mineral fibers and/or mineral yarns.

In accordance with another aspect of the invention, the intermediate layer can be made of an inorganic material.

In accordance with another aspect of the invention, the method can further include providing the inorganic material as one or more of ceramic material, fiberglass, silica, basalt, s-2 glass, and HR fiberglass.

In accordance with another aspect of the invention, the method can further include providing the layer of compressible material as a compression pad, 3D textile, spacer fabric having multiple layers of textile fabric, or foam.

In accordance with another aspect of the invention, the method can further include providing the layer of compressible material having a compression force deflection curve that allows for significant compression and recovery properties, relative to a percentage of a relaxed thickness extending across a width from one side to an opposite side of the second layer.

In accordance with another aspect of the invention, the method can further include providing the layer of compressible material such that the compressible material can compress up to 90% of its relaxed thickness and recover to its original relaxed thickness after being compressed.

In accordance with another aspect of the invention, the method can further include bonding an adhesive to an outwardly facing surface of at least one of the compressible material and the coating layer.

### BRIEF DESCRIPTION OF THE DRAWINGS

These and other aspects, features and advantages will become readily apparent to those skilled in the art in view of the following detailed description of presently preferred embodiments and best mode, appended claims, and accompanying drawings, in which:

FIG. 1 is a schematic perspective view of an electric motor vehicle having a battery pack with a multilayer thermal insulator constructed in accordance with an aspect of the invention;

FIGS. 2A-2C illustrate a schematic representation of an electric vehicle battery pack in accordance with prior art undergoing a thermal runaway condition with a flame propagating without hindrance from a location of flame initiation (FIG. 2A) throughout a plurality of cells of the battery pack (FIG. 2C);

FIGS. 3A-3C are views similar to FIGS. 2A-2C, with the electric vehicle battery pack including one or more flexible multilayer battery pack insulators constructed in accordance with an aspect of the disclosure, with the flexible multilayer battery pack insulators shown suppressing and inhibiting flame propagating from a location of a thermal runaway condition within a single cell (FIG. 3A) throughout the plurality of cells of the battery pack (FIG. 3C);

FIG. 4A is a schematic plan view of one of the flexible multilayer battery pack insulators;

FIG. 4B is a cross-sectional view taken generally along the line 4B-4B of FIG. 4A;

FIG. 5 is a cross-sectional view taken generally along a region denoted by line 5-5 of FIG. 4A;

FIG. 6A is a view similar to FIG. 4A of a flexible multilayer battery pack insulator constructed in accordance with another aspect of the disclosure illustrating the layers stitched together via a quilting process;

FIG. 6B is a cross-sectional view taken generally along the line 6B-6B of FIG. 6A;

FIG. 7A is a partial side view of one of the layers of FIG. 5 shown while in a relaxed, non-compressed state;

FIG. 7B is a view similar to FIG. 7A illustrating the layer while in a compressed state; and

FIG. 8 is a compression curve of the layer illustrated in FIGS. 7A and 7B.

### DETAILED DESCRIPTION OF PREFERRED EMBODIMENTS

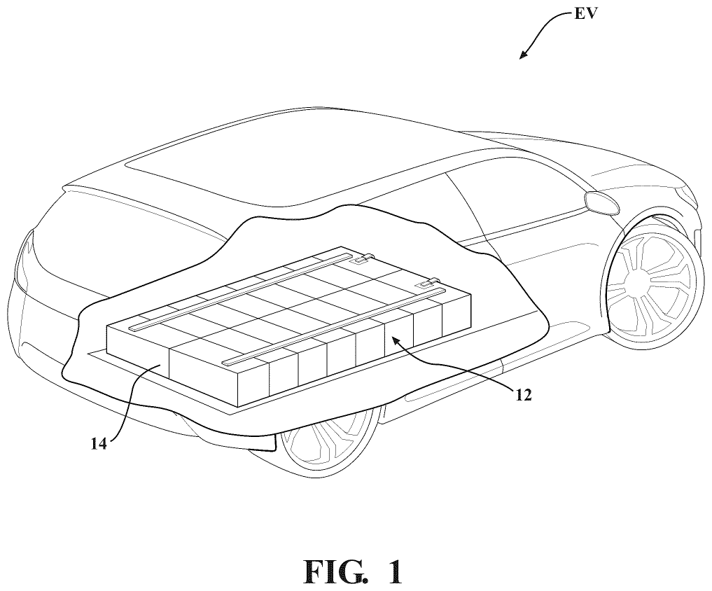

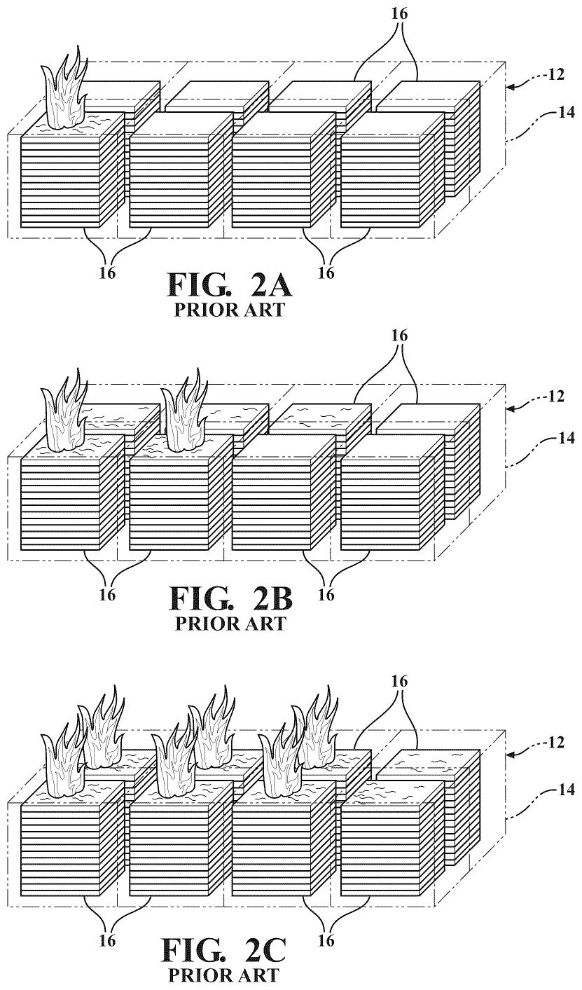

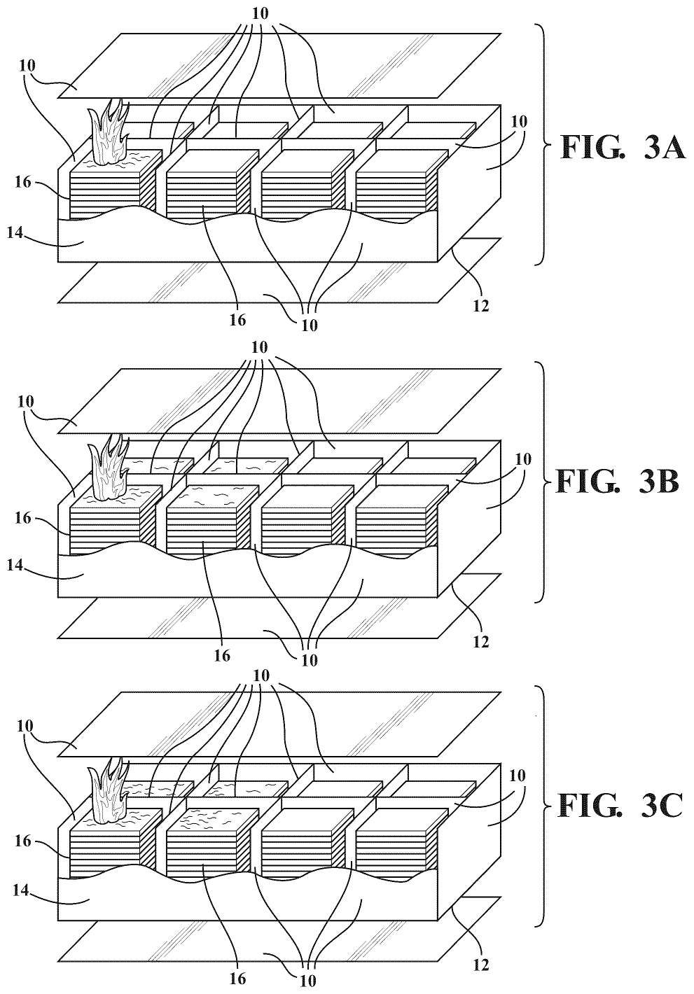

Referring in more detail to the drawings, FIG. 1 illustrates a motor vehicle, shown as an electrically powered motor vehicle, also referred to as electric vehicle EV, having a battery pack 12, such as a lithium-ion battery pack, configured with at least one insulator material, and shown as plurality of insulator materials, also referred to as flexible multilayer battery pack insulator or thermal insulator 10, in accordance with an aspect of the invention. The electric vehicle battery pack 12 includes a housing member, also referred to as housing or casing 14 bounding a plurality of cells 16, and optionally including one or more of bus-bars electrically interconnecting cells with one another, high voltage electrical connectors, cell interfaces, low voltage signal wires, high voltage cables and a cooling system having cooling tubes through which coolant can flow, as is generally known in electric vehicle battery packs. During normal use, and including in non-normal or abnormal situations, such as in a vehicle crash condition or some other condition causing damage or an impact force to battery pack 12, in contrast to a battery pack 12 not having a thermal insulator 10 as disclosed herein, as shown in FIGS. 2A-2C, a thermal runaway condition originating in any one of the cells 16 of a battery pack 12, with the flexible thermal insulator 10 being disposed between and/or about the cells 16, as illustrated in FIGS. 3A-3C, is controlled and contained within the cell of excessive heat and/or flame origin via the flexible thermal insulator 10, such that flame propagation from the cell of heat and/or flame origin to adjacent cells 16 is prevented for at least 10 minutes at an internal cell temperature ranging between 1200-1400° C., and an outer surface temperature of the housing 14 is maintained to be less than 200° C., and preferably 150° C., for at least 10 minutes.

As shown schematically in FIGS. 3A-3C, the thermal insulator(s) 10, which can be arranged between adjacent cells 16 to thermally separate and isolate the cells 16 from one another, as well about at least a portion of the battery pack housing 14 so as to thermally shield and protect surfaces of the battery pack housing 14, the aforementioned bus-bars, high voltage electrical connectors, cell interfaces, low voltage signal wires, high voltage cables and any cooling tubes (not shown) against extreme temperature thermal runaway conditions as well as against contamination, such as from fluid or debris, and further against impact forces, such as may be experienced in a crash condition, is provided as a relatively thin, flexible multilayer wall 18, such as having a thickness as low as 0.1 mm up to about 11 mm, and preferably between about 1 mm-2 mm in thickness. The wall 18, being thin and flexible, can be configured and contoured as needed, such as by being able to be wrapped into a hollow tubular sleeve configuration about bus bars, wires, tubes, connectors and the like, and can also be used in sheet form, such as a flat planar sheet, to provide a protective outer barrier about an outer periphery of the cells 16, as well as to provide a protective barrier between adjacent cells 16 to effectively thermally isolate each cell 16 from an adjacent cell 16.

The composite wall 18, as shown in a schematic cross-section in FIG. 5 includes a first layer provided as a coating layer 20 having opposite outer and inner sides 20a, 20b. Composite wall 18 further includes a second layer provided as a compressible material 22 having opposite outer and inner sides 22a, 22b. Further, composite wall 18 includes an intermediate layer, provided as a fabric layer 24, wherein fabric layer 24 is sandwiched, also referred to as captured, between the inner side 20b of the first layer 20 and the inner side 22b of the second layer 22. It is to be recognized that the term “inner side,” with reference to inner sides 20b, 22b is intended to identify the sides that face inwardly toward the intermediate layer 24.

To facilitate locating and fixing the thermal insulator 10 in place, at least one, and shown as a pair of adhesive layers 26a, 26b can be fixed, such as via being bonded, to the respective outer side 20a of the first layer 20 and to the outer side 22a of the second layer 22, if desired. The adhesive layers 26a, 26b can be provided as pressure-sensitive adhesive layers 26a, 26b that are fire-resistant, and in one preferred embodiment, provided as an acrylic adhesive. A release layer 28a, 28b can be releasably bonded to an outwardly facing side of the pressure-sensitive adhesive layer 26a, 26b, facing away from the intermediate layer 24, for selective removal to expose the underlying pressure-sensitive adhesive layer 26a, 26b, if provided, when desired for adhesion to a desired surface of the electric vehicle battery pack 12. The pressure-sensitive adhesive layer 26a, 26b in accordance with the disclosure herein, if provided, provides a minimum peal strength of 5N/25 mm under normal operating conditions.

The coating material of the first layer 20 includes at least one flame resistant/retardant material(s). The coating material of the first layer 20 can withstand heat as high up to 1600° C. The coating material of the first layer 20 can include intumescent material, and can include, in part or in entirety, vermiculite.

The intermediate layer 24 can be provided including one or more of a nonwoven material, and/or woven material, and/or knitted material. The intermediate layer 24 can be made of mineral fibers and/or mineral yarns. The intermediate layer 24 can be made of an inorganic material, wherein the inorganic material can include one or more of a ceramic material, fiberglass, silica, basalt, s-2 glass, and HR fiberglass, including intertwined fibers (nonwoven) thereof or interlaced (woven or knitted) multifilament yarns thereof.

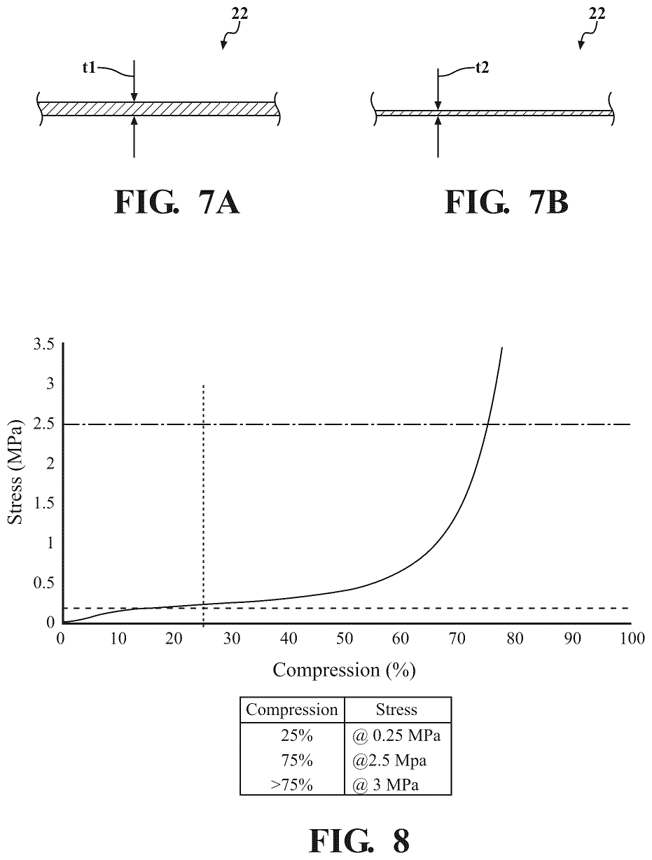

The compressible material of the second layer 22 can be provided as one of a compression pad, a 3D textile, a spacer fabric having multiple layers of textile fabric connected to one another, or foam. The compressible material of the second layer 22 provides a compression force deflection curve (FIG. 8) that allows for significant compression and recovery properties, relative to a percentage of an uncompressed, relaxed thickness extending across a width, also referred to as thickness, from one side to an opposite side of the second layer 22, wherein the compressible material 22, as shown in FIGS. 7A and 7B, can be provided to compress up to 25%, and preferably up to 50%, and more preferably up to 90% of its relaxed, uncompressed thickness t1 (FIG. 7A) to a compressed thickness t2 (FIG. 7B), and immediately recover to its original relaxed thickness t1 after being compressed. Accordingly, the second layer 22 allows for lateral shifting of cells 16 relative to one another, such that adjacent cells 16 can move toward and away from one another without causing internal stresses within the separate cells 16, thereby avoiding damage from being caused to the neighboring cells 16 during cyclic thermal events.

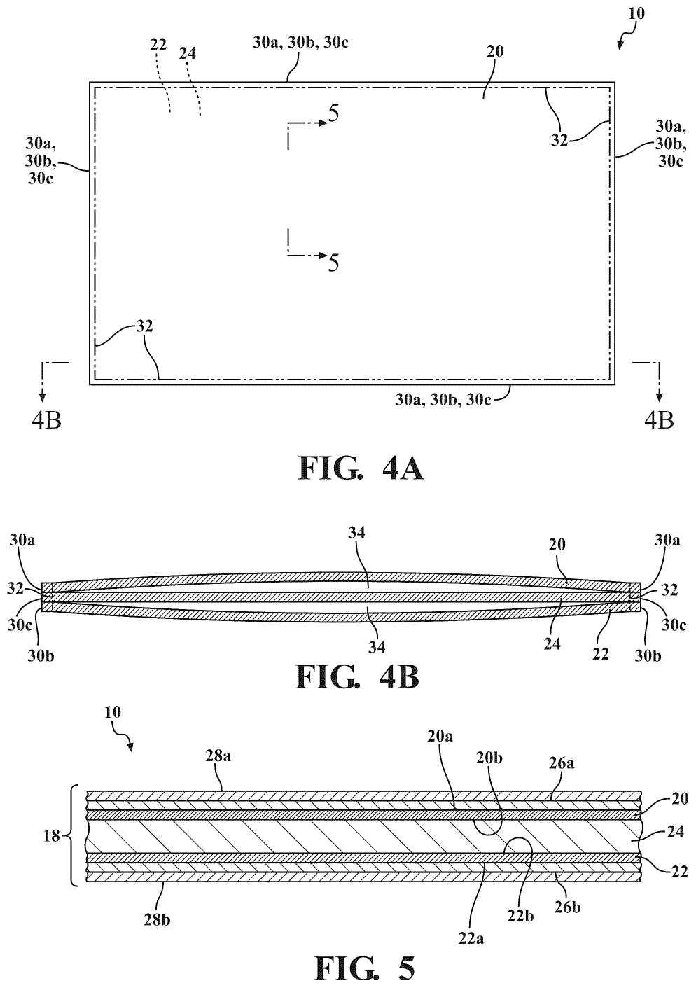

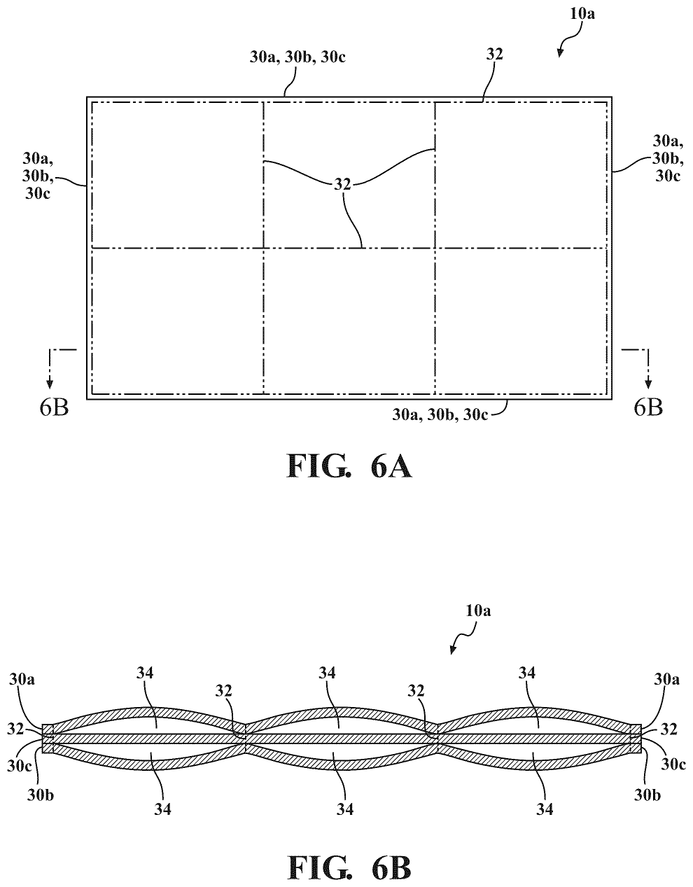

The first layer 20, the second layer 22, and the intermediate layer 24 are fixed together, and can be fixed together via a stitching process, such as a sewing (FIGS. 4A and 4B) or quilting (FIGS. 6A and 6B) process, by way of example and without limitation. The first outer film layer 20, the second outer layer 22, and the intermediate fabric layer 24, as shown in FIGS. 4A and 4B, have outer peripheries 30a, 30b, 30c, respectively, and can be fixed together via at least one stitch, also referred to as yarn or filament 32, in the stitching and quilting processes, where the stitch 32, by way of example and without limitation, is shown extending adjacent the outer peripheries 30a, 30b, 30c, and shown as extending immediately along and through the outer peripheries 30a, 30b, 30c, thereby sealing the outer peripheries 30a, 30b, 30c against ingress of water or debris, as well as acting to fix the layers 20, 22, 24 to one another. The first outer film layer 20, the second outer layer 22, and the intermediate fabric layer 24 can remain, in their entireties, detached from one another inwardly of the stitch 32, and thus, allow an air layer or air gap 34 to remain or form between the separate layers 20, 22, 24, thereby increasing the thermal insulation properties of the thermal insulator 10. It is to be recognized that the stitch 32, as formed in a quilting process (FIGS. 6A and 6B) can include a plurality of stitches in any desired pattern, spaced from one another to form multiple air gaps, also referred to as air pockets or air layers 34, therebetween, if desired.

In accordance with another aspect of the invention, a method of constructing an insulator material 10 for use with an electric vehicle battery pack 12 is provided. The method includes providing a first layer as a coating layer 20 having opposite outer and inner sides 20a, 20b, a second layer as a compressible material 22 having opposite outer and inner sides 22a, 22b, and an intermediate layer as a fabric layer 24 sandwiched between the inner side 20b of the first layer 20 and the inner side 22b of the second layer 22, and, fixing the first layer 20, the second layer 22, and the intermediate layer 24 to one another.

In accordance with another aspect of the disclosure, the method can further include fixing at least some of the layers 20, 22, 24 together via at least one stitch 32.

In accordance with another aspect of the disclosure, the method can further include leaving the first layer 20, the second layer 22, and the intermediate layer 24 in detached relation from one another other than where fixed together.

In accordance with another aspect of the disclosure, the method can further include forming the at least one stitch 32 along opposite outer peripheries 30a, 30b, 30c of the first layer 20, the second film layer 22, and the intermediate layer 24.

In accordance with another aspect of the disclosure, the method can further include fixing the layers 20, 22, 24 to one another via a quilting process (FIGS. 6A and 6B) to provide air pockets 34 between the layers 22, 22, 24, with the air pockets 34 being bounded by stitching 32 of the quilted layers 20, 22, 24.

In accordance with another aspect of the disclosure, the method can further include providing the first layer 20 as a coating having at least one flame resistant/retardant material(s).

In accordance with another aspect of the disclosure, the method can further include providing the coating layer 20 being able to withstand heat as high up to 1600° C.

In accordance with another aspect of the disclosure, the method can further include providing the coating layer 20 including, in part or in entirety, vermiculite.

In accordance with another aspect of the disclosure, the method can further include providing the intermediate layer 24 as one of a nonwoven material, woven material, and knitted material.

In accordance with another aspect of the disclosure, the method can further include providing the intermediate layer 24 being made of intertwined mineral fibers and/or interlaced mineral yarns.

In accordance with another aspect of the disclosure, the method can further include providing the intermediate layer 24 being made of an inorganic material, wherein the inorganic material can include one or more of a ceramic material, fiberglass, silica, basalt, s-2 glass, and HR fiberglass.

In accordance with another aspect of the disclosure, the method can further include providing the second layer 22 as one of a compression pad, 3D textile, spacer fabric having multiple layers of textile fabric connected to one another, or foam.

In accordance with another aspect of the disclosure, the method can further include providing the compressible material of the second layer 22 having a compression force deflection curve (FIG. 8) that allows for significant compression and full recovery properties, relative to a percentage of a relaxed thickness extending across a width from one side to an opposite side of the second layer 22, wherein the compressible material 22, as shown in FIGS. 7A and 7B, can be provided to compress up to 90% of its relaxed thickness t1 (FIG. 7A) to a compressed thickness t2 (FIG. 7B), and immediately recover to its original relaxed thickness t1 after being compressed.

In accordance with another aspect of the disclosure, the method can further include applying the coating layer 20 to the intermediate layer 24 after fixing the intermediate layer 24 to the compressible second layer 22.

In accordance with another aspect of the disclosure, the method can further include applying the coating layer 20 to the intermediate layer 24 before fixing the intermediate layer 24 to the compressible second layer 22.

In accordance with another aspect of the disclosure, the method can further include bonding at least one or a pair of adhesive layers 26a, 26b to the respective outer side 20a of the first layer 20 and to the outer side 22a of the second layer 22.

Obviously, many modifications and variations of the present invention are possible in light of the above teachings. It is contemplated that all features of all claims and of all embodiments can be combined with each other, so long as such combinations would not contradict one another. It is, therefore, to be understood that within the scope of the appended claims, the invention may be practiced otherwise than as specifically described.

What is claimed is:

1. A flexible multilayer battery pack insulator for an electric vehicle, comprising:
a first layer of a coating material having opposite outer and inner sides;
a second layer of compressible material having opposite outer and inner sides; and
an intermediate fabric layer sandwiched between said inner side of said first layer and said inner side of said second layer,
wherein the second layer has a relaxed thickness extending from the inner side to the opposite outer side of the second layer, wherein second layer can compress up to 50% of the relaxed thickness and recover to the relaxed thickness.

2. The flexible multilayer battery pack insulator of claim 1, wherein the second layer can compress up to 90% of the relaxed thickness and recover to the relaxed thickness.

3. The flexible multilayer battery pack insulator of claim 1, wherein the first layer includes at least one flame resistant/retardant material that can withstand heat up to 1600° C.

4. The flexible multilayer battery pack insulator of claim 3, wherein the first layer includes vermiculite.

5. The flexible multilayer battery pack insulator of claim 1, wherein the first layer is an intumescent material.

6. The flexible multilayer battery pack insulator of claim 1, wherein the intermediate fabric layer is one of a nonwoven material, a woven material, or a knitted material.

7. The flexible multilayer battery pack insulator of claim 6, wherein the intermediate fabric layer is made of mineral fibers and/or mineral yarns.

8. The flexible multilayer battery pack insulator of claim 7, wherein the intermediate fabric layer is made of one or more of a ceramic material, fiberglass, silica, basalt, s-2 glass, and HR fiberglass.

9. The flexible multilayer battery pack insulator of claim 1, wherein the first layer, the second layer, and the intermediate fabric layer are fixed together via stitching.

10. The flexible multilayer battery pack insulator of claim 9, wherein at least one air pocket is formed between the stitching.

11. The flexible multilayer battery pack insulator of claim 9, wherein the first layer and the intermediate fabric layer, or the second layer and the intermediate fabric layer are fixed together via an adhesive.

12. The flexible multilayer battery pack insulator of claim 1, wherein the first layer, the intermediate fabric layer, and the second layer are fixed together via an adhesive.

13. The flexible multilayer battery pack insulator of claim 1, further including an adhesive layer bonded to at least one of the outer surfaces of the first and second layers.

14. The flexible multilayer battery pack insulator of claim 13, further including a release layer releasably bonded to the adhesive layer.

15. The flexible multilayer battery pack insulator of claim 1, wherein the second layer of compressible material is one of a compression pad, 3D textile, spacer fabric having multiple layers of textile fabric, or foam.

16. A method of constructing a flexible multilayer battery pack insulator, comprising:
providing a first layer of a coating material having a first layer outer side and an opposite first layer inner side;
providing a second layer of compressible material having a second layer outer side and an opposite second layer inner side and having a relaxed thickness extending between the second layer inner side and the second layer outer side, with the second layer being able to compress up to 50% of the relaxed thickness and recover to the relaxed thickness; and
sandwiching an intermediate layer of fabric material between the inner side of the first layer and the inner side of the second layer.

17. The method of claim 16, wherein the relaxed thickness is able to compress up to 90% of the relaxed thickness and recover to the relaxed thickness.

18. The method of claim 16, further including providing the first layer including vermiculite.

19. The method of claim 16, further including providing the first layer including an intumescent material.

20. The method of claim 16, further including fixing the first, second, and intermediate layers together via thread in a sewing process and leaving the first layer, the second layer, and the intermediate layer detached from one another other than where fixed together by the thread, with air pockets formed between the first layer, the second, and the intermediate layer.
